(19) United States
(12) Patent Application Publication
(10) Pub. No.: US 2010/0181746 A1
(43) Pub. Date: Jul. 22, 2010

(54) AIRBAG MODULE HOUSING

(76) Inventors: Larry D. Rose, South Weber, UT (US); Charles Peter Caruso, JR., Bountiful, UT (US)

Correspondence Address: AUTOLIV ASP, INC., 3350 Airport Road, Ogden, UT, 84405, US

(21) Appl. No.: 12/355,429

(22) Filed: Jan. 16, 2009

(51) Int. Cl. B60R 21/26

(52) U.S. Cl. 280/736

(57) ABSTRACT

A passenger airbag module that includes an airbag and a tubular inflator. The tubular inflator produces a quantity of inflation gas sufficient to inflate the airbag. The module also includes a housing that receives the inflator; and a retainer positioned within the airbag. The retainer clamps the airbag and the inflator to the housing, thereby creating a retainer/housing assembly having an annular gap proximate the inflator, the gap allowing the gas to exit the inflator and enter the airbag. In some situations, the gap will gap circumscribe the inflator.

### BACKGROUND OF THE INVENTION

Airbags and airbag technology have been credited with saving many lives and greatly improving the safety of motor vehicles. Accordingly, airbag systems are now standard and required on most new vehicles sold throughout the world.

One type of airbag system known in the art is the so-called “passenger airbag.” This airbag is mounted in the vehicle's dashboard and is designed to protect a vehicle occupant seated in the vehicle's front passenger seat. Passenger airbags are mandatory on most new vehicles.

Of course, vehicle manufacturers are looking for smaller, more efficient passenger airbag systems. Hopefully, these smaller units will cost less to manufacture, will weight less and will occupy less volume.

Tubular-shaped inflators may be used as part of a passenger airbag system. However, passenger airbag systems that use tubular-shaped inflators can be expensive, heavy, and may be difficult to manufacture. Such disadvantages are primarily caused by the need to contain and redirect high-pressure gas during deployment. In order to do this, most designs use tubes or circular-shaped airbag housings to contain and redirect the inflation gas produced by the inflator. However, the present embodiments are designed to produce a new passenger airbag module that may be used with a tubular inflator. Such a device is disclosed herein.

### BRIEF SUMMARY OF THE INVENTION

A passenger airbag module is disclosed. This module comprises an airbag and a tubular inflator. The tubular inflator is used to produce a quantity of inflation gas sufficient to inflate the airbag. The module also includes a housing that receives the inflator and a retainer. The retainer is positioned within the airbag, wherein the retainer clamps the airbag and the inflator to the housing, thereby creating a retainer/housing assembly having an annular gap proximate the inflator, the gap allowing the gas to exit the inflator and enter the airbag. In some embodiments, the gap circumscribes the inflator. In other embodiments, the gap between the inflator and a lateral side of the airbag retainer is at least 10 millimeters.

The retainer and/or the housing may comprise one or more stiffening walls that extend outward from a base. In one embodiment, the height of the retainer's stiffening walls and/or the height of the housing's stiffening wall may be at least 15% of the distance between two fasteners used to secure the retainer. In other embodiments, the height of the retainer's stiffening walls and/or the height of the housing's stiffening wall may be at least 15% of the distance between two openings. In other embodiments, the housing may comprise one or more rigid sidewalls that extend outward from a base, the rigid side walls creating a area that holds the airbag. In other embodiments, four fasteners that connect the retainer to the housing may be used. In some embodiments, the diameter of the housing changes to facilitate alignment of the inflator within the housing.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an exploded assembly view of an airbag module according to the present embodiments;

FIG. 2 is a transverse sectional view of the fully assembled embodiment of FIG. 1;

FIG. 3 is a side view of the fully assembled embodiment of FIG. 1;

FIG. 4 is a perspective view of another embodiment of an airbag module according to the present embodiments;

FIG. 5 is a longitudinal sectional view of the fully assembled embodiment of FIG. 1;

FIG. 6 is an exploded, assembly view of the embodiment of FIG. 1 showing the way in which it may be mounted to a vehicle;

FIG. 6A is an end view of the embodiment of FIG. 6 showing inflator and the housing; and

FIG. 7 is a fully assembled view of the embodiment of FIG. 6.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

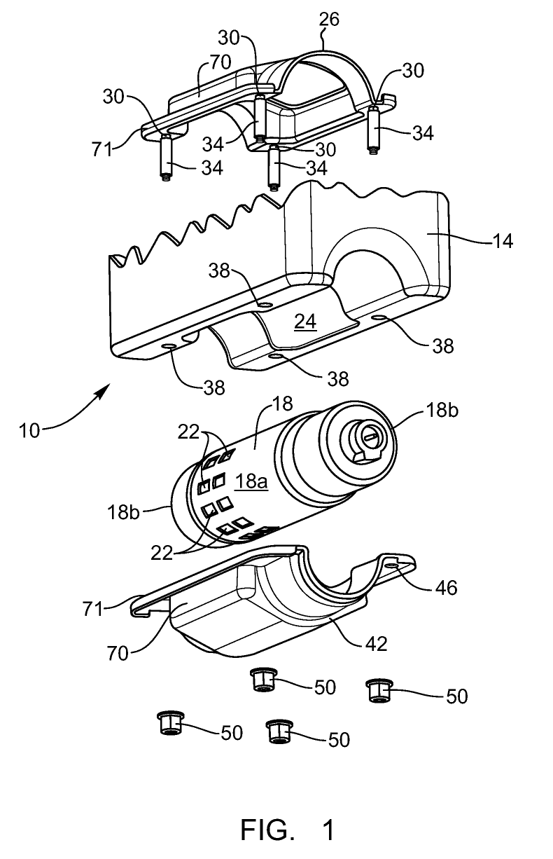

Referring to FIG. 1, an exploded assembly view of a passenger airbag module 10 according to the present embodiments is illustrated. The passenger airbag module 10 may be used on the passenger-side of a vehicle to protect an occupant seated in the front-passenger side. (The module 10 may also be referred to as an airbag assembly 10). The passenger airbag module 10 includes an airbag 14 (shown in cut-away for clarity and so not to obscure other components) that may be inflated in front of the occupant in the event of the crash. Those skilled in the art will appreciate the size, shape and configuration of the airbag 14. (The airbag 14 may also be referred to as a “cushion”). An inflator 18 is also used as part of the airbag module 10. The inflator 18 may be a tubular (cylindrical) inflator that is capable of producing/channeling a quantity of inflation gas into the airbag 14 to inflate and deploy the airbag 14. The inflator 18 may include an intermediate portion 18a that is positioned proximate the middle of the inflator 18. Two end portions 18b may also be present in the inflator 18.

The inflator 18 includes one or more exit holes 22 through which the inflation gas will flow during deployment. The gas will flow out of the exit holes through an opening 24 in the airbag 14 to allow the gas to enter the interior of the airbag 14. Again, those skilled in the art will appreciate that a variety of different inflators may be used.

An airbag retainer 26 is also used as part of the airbag module 10. The retainer 26 is designed such that it will be positioned on the interior of the airbag 14. Accordingly, when the airbag module 10 is constructed, the airbag 14 will have an open top portion to allow the retainer 26 to be positioned on the interior of the airbag 14. Once positioned, the airbag 14 may then be sewn or sealed so that it is capable of receiving the quantity of inflation gas during deployment. (The top of the cushion 14, is not shown for clarity. However, it will be appreciated that the retainer will be inside the cushion 14 when properly positioned.) In other embodiments, including some of the presently preferred embodiments, the retainer 26 may be inserted into the cushion 14 via the opening 24 at the bottom of the cushion 14. The retainer 26 may include holes 30 through which fasteners 34 may pass. These fasteners 34 may pass through similar openings 38 in the airbag 14. The present embodiments may be a four (4) fastener (stud) assembly.

A housing 42 is also added to the airbag module 10. The housing 42 is designed to receive the inflator 18. In other words, the inflator 18, when the module 10 is fully assembled, will be at least partially situated in the housing 42. The housing 42 may include openings 46 through which the fasteners 34 may pass. Nuts 50 may be used in conjunction with these fasteners 34.

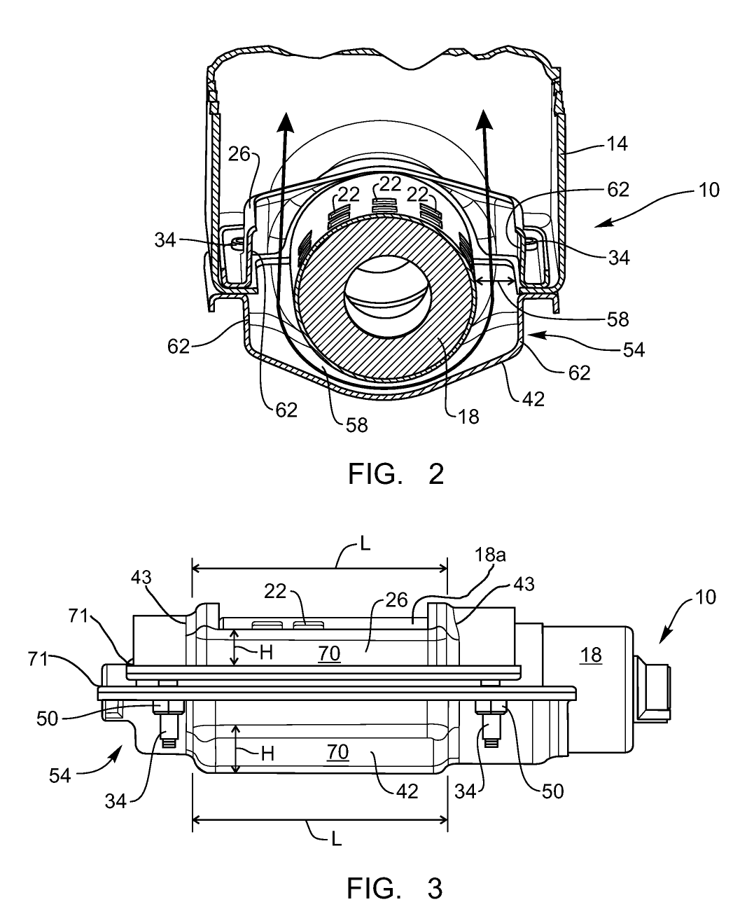

FIG. 2 is a sectional view showing the module 10 of FIG. 1 in its fully assembled configuration. Accordingly, referring collectively to FIGS. 1-2, the retainer 26 clamps the airbag 14 and the inflator 18 to the housing 42. Such a “clamshell” module creates a retainer/housing assembly 54 that surrounds the inflator 18. However, this assembly 54 includes an annular gap 58 that surrounds the inflator 18. This gap 58 is an open area around the inflator 18 that ensures than the openings 22 are not occluded or blocked by the walls of the housing 42 or the retainer 26. The gap 58 may circumscribe the inflator 18. Thus, the gas flowing out of the inflator 18 will be able to rapidly escape the inflator 18 and deploy the airbag 14.

It should be noted that the lateral sides 62 of the retainer 26 and/or the housing 42 constitute the area of the retainer 26/housing 42 that is closest to the inflator 18. However, in the embodiment shown in FIG. 2, even at this closest point, the gap 58 between the inflator and the retainer 26/housing 42 may be at least 10 millimeters. The arrows show the gas flow through this area.

FIG. 3 is a side view of the assembly 54 that shows some additional features of the airbag module 10. Specifically, as shown in FIG. 3, the retainer 26 and/or the housing 42 may include one or more stiffening walls 70. (These stiffening walls 70 are also shown in FIG. 1 for reference). The stiffening walls 70 are vertical walls that extent outwardly of either the retainer 26 or the housing 42 and may extend from a base 71 of either the housing 42 or the retainer 26. (The stiffening walls 70 may be portions of the lateral sides 62 or may be separate features added to the sides 62). The walls 70 may be designed in which the height (H) of the wall is at least 15% of the length (L) of the wall. The length of the wall 70 is generally the longitudinal length that may be between the two midpoints of the openings that are designed to receive the fasteners 34. In other embodiments, the length may be the total length between wall ends 43. In other embodiments, the length may be the distance between the center of the two fasteners 34. As the gas generally flows outward from the inflator 18, these outwardly extending walls 70 direct into the airbag 14. Of course, other embodiments may be designed in which the fasteners are moved outwards, but the total module is made wider.

As shown in FIG. 3, one of the advantages of the airbag module 10 is that the inflator 18 nests within the housing 42 such that the housing 42 will support each of the opposing ends of the inflator 18 while the intermediate portion 18a of the inflator 18 is suspended from the housing 42 to create the gap 58 (see FIG. 2). The retainer 26 operates to clamp the airbag 14 against the inflator 18 and the housing 42.

It should be known that the retainer 26 will retain the airbag 14 whereas the housing 42 retains the inflator 18. The clamping together of the retainer 26 and the housing 42 prevents or minimizes gas leakage in the vicinity of the clamping. The advantages of this design include allowing the gas to be directed into the airbag with minimal or no gas leakage. In fact, even low pressure gas may flow into the airbag 14. Further, the present embodiments minimize the fastener usage and the number of required parts, yet still retain the airbag without having the airbag “pull out.” Also, the present embodiments allow for an error-proof installation (described herein) and may be adaptable to longer inflators and/or lighter or even full-steel housings 42. Further, the likelihood that there will be compression damage to the housing 42 during the assembly process or use is minimized.

In some embodiments the retainer 26 may be constructed of 1.2 mm steel (or any other type of metal) and have mass (with the fasteners 34 having a mass of 108 grams). The fasteners 34 may be M6 clinch studs or any other type of suitable fastener. M6 studs are fasteners that have a 6 millimeter diameter (the diameter measured at the threaded portion below the head of the fastener). The housing 42 may be constructed of similar material (1.2 mm steel or any other type of metal) and have a mass of 190 grams. The nuts 50 may be M6 nuts with nylon inserts. Of course, other types of nuts 50 may also be used. V.E.V.A. skills may also be used. V.E.V.A. refers to “Value Engineering Value Analysis” which involves finding ways to reduce costs through good engineering practices. For examples, V.E.V.A. may be applied to modify the fasteners, retainer and/or housing to make them thinner, thereby reducing cost and weight. Those skilled in the art would appreciate how V.E.V.A. may be applied, as needed.

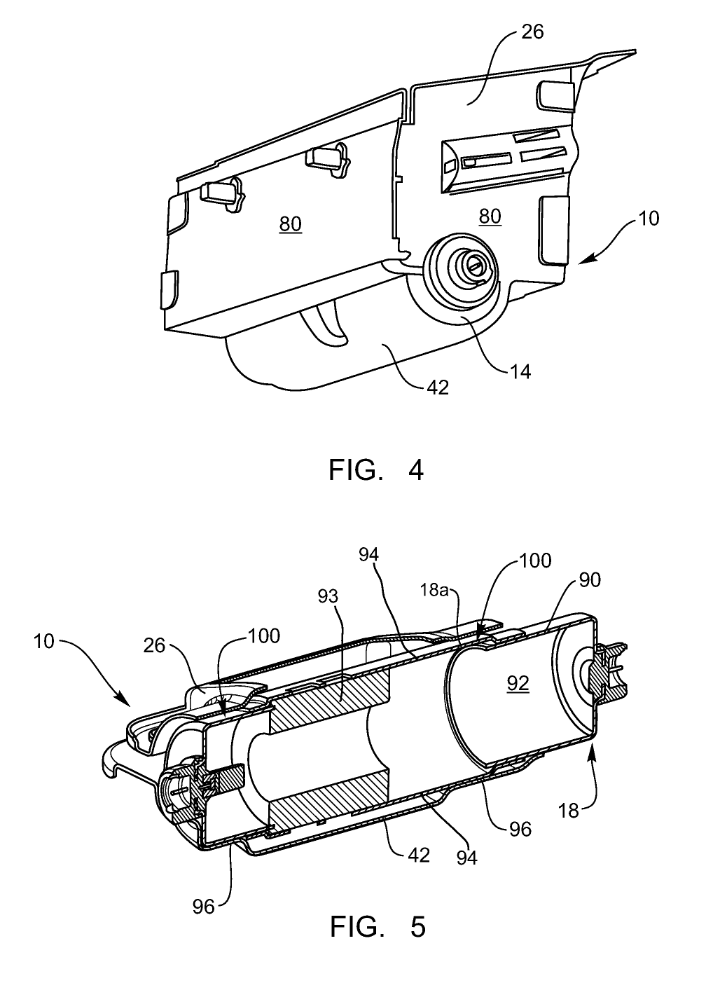

FIG. 4 is a perspective view of another embodiment of the present invention. In the embodiment of FIG. 4, the housing 42 lacks any stiffening walls 70. (The retainer 26 also lacks the stiffening walls 70). Rather, the housing 42 includes rigid walls 80 that create a package that houses the uninflated airbag 14. This housing 42 may be made of full steel or other metal. In all other aspects, this embodiment of FIG. 4 is similar to the above-recited embodiments. In other words, a gap 58 (not shown in FIG. 4) may still be present between the interior of the housing 46 and the inflator 18. As with the prior embodiment, the retainer 26 may be positioned within the airbag 14.

Referring now to FIG. 5, a cross-sectional view of the embodiment of FIG. 3 is illustrated. In this embodiment, some features of the assembly 10 are illustrated. Particularly, the inflator 18 may include a smaller diameter area 90. The housing 42 and the retainer 26 do not contact the smaller diameter area 90. In fact, this smaller diameter area 90 “error proofs” the installation process with respect to the end-to-end (longitudinal) alignment of the inflator 18. If the installer accidentally tries to install the housing 42 and/or the retainer 26 in the wrong position with respect to the inflator 18, the housing 42 and/or the retainer 26 will not fit around and/or engage the smaller diameter area 90. Thus, the installer will know that this configuration is incorrect and will re-position and/or adjustments to the assembly 10.

As is known in the industry, the inflator 18 may include a combustion chamber 92 and/or a filter 93 and a housing 94. Each of these features may be elongated, as desired, to modify the load and/or inflation capacity of the inflator 18.

In order to properly engage the housing 42, the inflator 18 may include clamp joints 96, which constitute areas where the metal of the housings 42 engages the metal of the inflator 18. Likewise, there may be joints 100 which are areas designed to clamp the airbag 14 (not shown) between the retainer 26 and the inflator 18. One or more nuts 130, as is known in the art, may also be used to connect the module together.

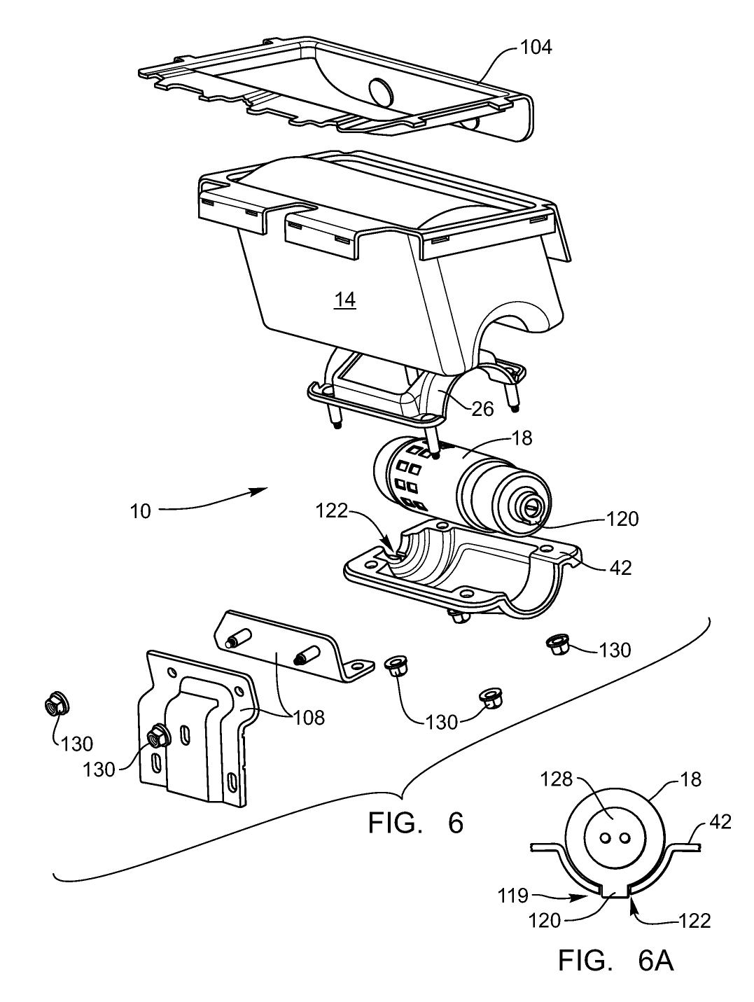

The inflator 18 in the present embodiments may also include a clocking feature 119. This feature is best shown in FIG. 6A, which is an end view of the inflator 18. This clocking feature 119 comprises a key 120 positioned on at least one end 128 of the inflator 18. In some embodiments, a key 120 will be positioned at both ends of the inflator 18. A corresponding slot 122 is positioned on the housing 42. The key 120 will fit into the slot 122 when properly positioned. The interaction between the key 120 and the slot 122 creates the “clocking” feature (which is sometimes called a “key-way feature”) that prevents the inflator 18 from rotating and holds the inflator 18 in the proper position. Other types of features that may be used to hold the inflator in place may also be used.

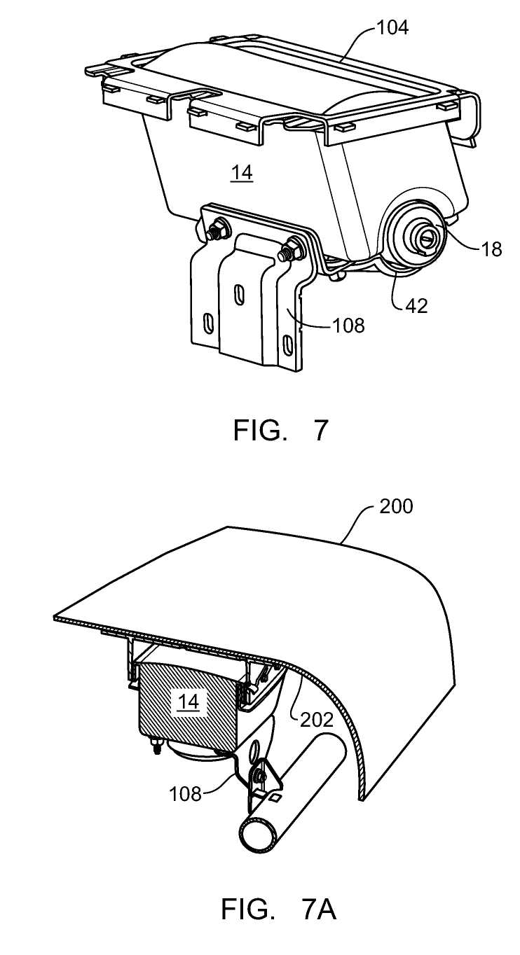

Referring now to FIGS. 6 and 7, an exploded assembly view (FIG. 6) illustrates the module 10 and the way in which it may be configured in conjunction with an airbag 14. FIG. 7 shows the module 10 in the fully assembled configuration. More specifically, the airbag 14 may be used with a B-ring 104 as is known in the art. Likewise, the housing 42 may be attached to mounting features 108 that are designed to secure the housing 42 to the vehicle structure. A variety of different structures may be used as the feature 108, all of which are preferred. A different structure of mounting features 108 are shown in FIG. 7A. When the airbag 14 is deployed, it will deploy through the B-ring 104 and become positioned within the vehicle interior in a position that will protect the occupant. The inflator 18 will be positioned within the housing 42 and the retainer 26 in the manner described herein. The inflator 18 may be cradled between the housing 42 and the inflator 26.

Further, FIG. 7A shows that the B-ring 104 is a rigid structural feature that attaches to the underside of the instrument panel 200. The B-ring 104 attaches to flanges (such as fabric flanges) on the airbag 14 and then attaches to the B-side (underside) 202 of the instrument panel via hooks, fasteners, or other attachment mechanisms.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A passenger airbag module comprising:
an airbag;
a tubular inflator having an intermediate portion between end portions, the inflator for producing a quantity of inflation gas sufficient to inflate the airbag;
a housing that receives the inflator; and
a retainer positioned within the airbag, wherein the retainer clamps the airbag and the inflator to the housing, thereby creating a retainer/housing assembly having an annular gap proximate the intermediate portion of the inflator, the gap allowing the gas to exit the inflator and enter the airbag.

2. A passenger airbag module as in claim 1 wherein the gap circumscribes the inflator.

3. A passenger airbag module as in claim 1 wherein the gap between the inflator and a lateral side of the airbag retainer is at least 10 millimeters.

4. A passenger airbag module as in claim 1 wherein the retainer comprises one or more stiffening walls that extend outward from a base.

5. A passenger airbag module as in claim 4 wherein the height of the retainer's stiffening walls is at least 15% of the distance between two openings in the retainer.

6. A passenger airbag module as in claim 1 wherein the housing comprises one or more stiffening walls that extend outward from a base.

7. A passenger airbag module as in claim 6 wherein the height of the housing's stiffening walls is at least 15% of the distance between two between two openings in the retainer.

8. A passenger airbag module as in claim 1 wherein the housing comprises one or more rigid sidewalls that extend outward from a base, the rigid side walls creating an area that holds the airbag.

9. A passenger airbag module as in claim 1 further comprising four fasteners that connect the retainer to the housing.

10. A passenger airbag module as in claim 9 wherein there are no more than four fasteners that connect the retainer to the housing.

11. A passenger airbag module as in claim 1 wherein the diameter of the inflator includes a smaller diameter area that is sized such that, if positioned within the housing and retainer, the smaller diameter area does not contact the housing or the retainer.

12. A passenger airbag module as in claim 1 wherein the inflator is cradled between the retainer and the housing.

13. A passenger airbag module as in claim 1 further comprising a clocking feature to prevent the inflator from rotating within the housing.

14. A passenger airbag module as in claim 13 wherein the clocking feature comprises a key disposed on at least one end of the inflator.

15. A passenger airbag module as in claim 1 wherein the airbag has an opening for receiving inflation gas from the inflator and the retainer is positioned within the airbag by passing the retainer through the opening into the airbag.
